(19) United States
(12) Patent Application Publication
(10) Pub. No.: US 2012/0323749 A1
(43) Pub. Date: Dec. 20, 2012

(54) SYSTEM AND METHOD FOR DATA PRIVACY AND CATEGORIZATION OF SALES AND USE TAX DATA

(76) Inventor: Neil N. Lapidus, (US)

(21) Appl. No.: 13/475,711

(22) Filed: May 18, 2012

Related U.S. Application Data
(60) Provisional application No. 61/487,643, filed on May 18, 2011.

(51) Int. Cl. G06Q 40/00

(52) U.S. Cl. 705/31

(57) ABSTRACT

A system may include a computing system comprising processing device, an input device, an output device, a storage device, and a network device. A computer program may configure the at least one computing system to receive, via the network device, sales and use tax data, store, on the storage device, the received sales and use tax data, extract an interstate sales entry from the stored sales and use tax data, analyze, using the processing device, the interstate sales entry to determine a jurisdiction associated with the interstate sales entry, privatize a SKU in the interstate sales entry, and store a transaction record in a database on the storage device, the transaction record including the determined jurisdiction and the privatized SKU.

### RELATED APPLICATIONS

This patent application claims the benefit of priority, under 35 U.S.C. Section 119(e), to U.S. Provisional Patent Application Ser. No. 61/487,643, entitled SYSTEM AND METHOD FOR DATA PRIVACY AND CATEGORIZATION OF SALES AND USE TAX DATA,” filed on May 18, 2011, which is incorporated by reference in its entirety.

### BACKGROUND

A use tax is paid by businesses/consumers on products and/or services that have been delivered to their current location by an out-of-state company (e.g., a person buys a computer from a California based company and has it delivered to his/her house in Minnesota). However, many times companies fail to pay the use tax. Additionally, unless a state knows about the sale there is no quickly verifiable way to accurately tax the purchaser if the purchaser fails to pay the use tax.

### BRIEF DESCRIPTION OF DRAWINGS

Some embodiments are illustrated by way of example and not limitation in the figures of the accompanying drawings in which:

FIG. 1A is a system diagram illustrating an example overview of a system to process sale and use tax data, according to an embodiment.

FIG. 1B is a diagram illustrating various jurisdictions, according to an embodiment.

FIG. 2 illustrates an example sale and use tax form, according to an example embodiment.

FIG. 3 is example out-of-state sales transaction data. according to an embodiment.

FIG. 4 is an example diagram of jurisdiction data, according to an embodiment.

FIG. 5 is an example database table, according to an embodiment.

FIGS. 6-7 are flowcharts illustrating example methods, according to various embodiments.

FIG. 8 is a block diagram of machine in the example form of a computer system within which a set instructions, for causing the machine to perform any one or more of the methodologies discussed herein, may be executed.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are illustrated in enough detail to enable those skilled in the art to practice the invention. The embodiments may be combined, other embodiments may be utilized, or structural, logical, and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Technical problems currently exist around privacy and categorization of sale and use tax data being exchanged between two jurisdictions (e.g., states). For example, a use tax is generally paid by businesses/consumers on products and/or services that have been delivered to their current location by an out-of-state company (e.g., a person buys a computer from a California based company and has it delivered to his/her house in Minnesota). Unless Minnesota knows about the computer sale there is no quickly verifiable way to accurately tax the purchaser if the purchaser fails to pay the use tax.

Currently, a state (e.g., California) may audit a company to determine if a sales and use tax return is accurate. As part of this process, California may request documentation of all out-of-state sales, which are deducted from tax owed. This documentation may then be transmitted to the taxing authority of the location of delivery of the out-of-state sale took place (e.g., Minnesota). Minnesota may then check to see if the receiver of the product paid the use tax. Additionally, each state has different use-based exemptions of what is subject to a sales or use tax. Therefore, states may be unnecessarily sending documentation to states on goods and services that are exempt from tax. Thus, the auditing process is inefficient, expensive and presents privacy concerns around the states having accessing to detailed sales information of its constituents.

In an embodiment, a system is used that helps to solve the technical problems of privacy and categorization that exist with using an audit-based approach to sales and use tax. In an embodiment, the system receives detailed transaction data on sales, privatizes the sales data, categorizes the privatized sales data, determines a governing jurisdiction at the location of delivery of the sale, compares the categorized data with a exemption table for the jurisdiction to determine if tax should be assessed on the sales, and synchronizes the results between the jurisdictions. While this document discusses management of sales and use tax with respect to the United States, the system may also be used between countries that implement a value-added tax.

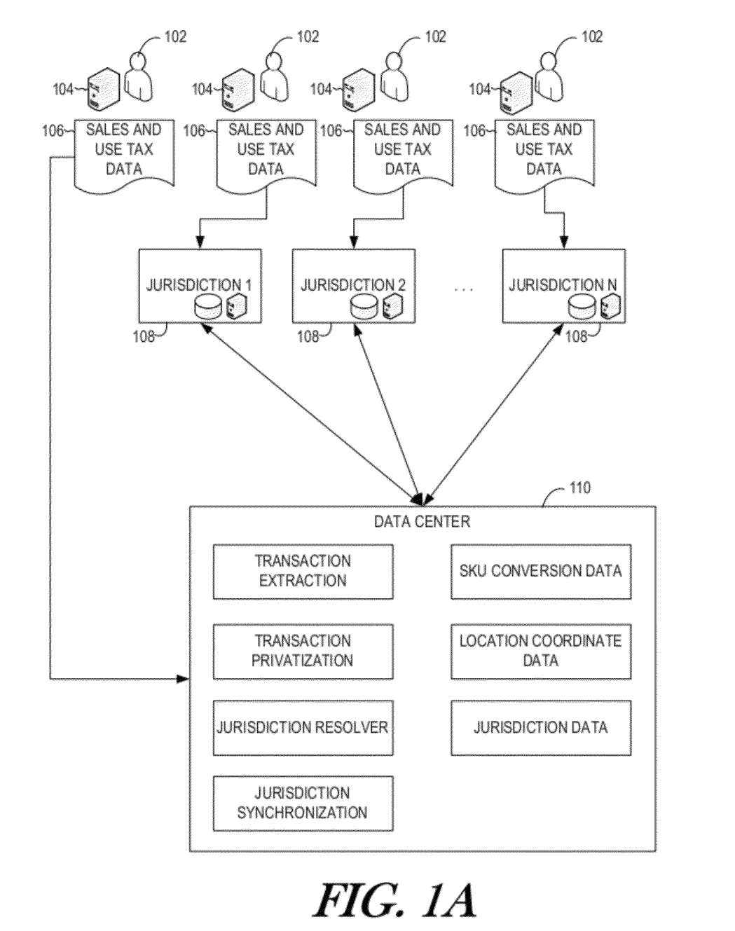

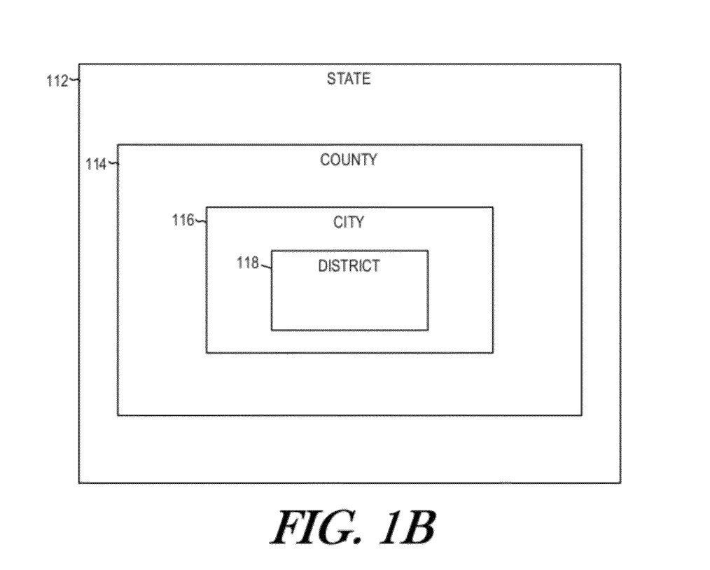

FIG. 1A is a system diagram illustrating an example overview of a system to process sale and use tax data. Shown are users 102, user terminals 104, sales and use tax data 106, jurisdictions 108, data center 110. In an embodiment, data center 110 includes transaction extraction, transaction privatization, jurisdiction resolver, SKU conversion table, location coordinate table, and jurisdiction table.

User terminal 104 may be a personal computer or mobile device. In an embodiment, user terminal 104 includes a client program to interface with data center 110 or jurisdictions 108 for, in an example embodiment, the purpose of uploading sales and use data 106. The client program may include commercial software, custom software, open source software, freeware, shareware, or other types of software packages. In an embodiment, the client program includes a thin client designed to provide query and data manipulation tools for a user of user terminal 104. The client program may interact with a server program hosted by, for example, data center 110 or jurisdictions 108.

In various embodiments, jurisdictions 108 represent one or more geographic areas that collect sales and use tax. Jurisdictions may be of various sizes and may be nested. For example, a state may include many jurisdictions, but a state itself may also be a jurisdiction. FIG. 1B illustrates a diagram of various types of jurisdictions. Illustrated is state jurisdiction 112 which includes county jurisdiction 114 which includes city jurisdiction 116 and which includes district jurisdiction 118. Each type of jurisdiction may include one or more other types of jurisdiction. Conversely, each type of jurisdiction may be part of one or more other types of jurisdiction.

In an embodiment, a jurisdiction is the entity to which state and use tax is owed. For example, a company with sales in county jurisdiction 114 may owe sales and use tax for that county, but also sales and use tax for state jurisdiction 116. Jurisdictions may also be defined by GPS coordinate data. In an embodiment, a jurisdiction may delegate its tax collecting responsibilities to another jurisdiction. For example, a state may collect sales and use tax on behalf of a district. By way of example, see Iowa form 32-022b and Nevada form TXR-01.01c for a list of jurisdictions and the various tax rates associated with each jurisdiction.

A jurisdiction may implement one or more servers to receive sales and use tax data such as that provided by users 102. In various embodiments, jurisdictions may contract with one or more third parties to manage the servers and process tax information. In an embodiment, jurisdictions 108 include a web server which may communicate with a file server to publish or serve files stored on the file server. The web server may also communicate or interface with an application server to enable web-based interfaces to receive and present information. For example, the application server may consist of scripts, applications, or library files that provide primary or auxiliary functionality to the web server (e.g., multimedia, file transfer, or dynamic interface functions). In addition, the application server may also provide some or the entire interface for the web server 108 to communicate with one or more of the other servers in system 100 (e.g., data center 110). The web server, either alone or in conjunction with one or more other computers in system 100, may provide a user-interface. The user-interface may be implemented using a variety of programming languages or programming methods, such as HTML (HyperText Markup Language), VBScript (Visual Basic® Scripting Edition), JavaScript™, XML® (Extensible Markup Language), XSLT™ (Extensible Stylesheet Language Transformations), AJAX (Asynchronous JavaScript and XML), Java™, JFC (Java™ Foundation Classes), and Swing (an Application Programming Interface for Java™). In various embodiments, jurisdictions 108 implement other non-HTTP based servers to receive sale and use data. For example, an FTP or SSH server may be used. In an embodiment, jurisdictions use an e-mail based system to receive the sale and use data.

In an embodiment, data center 110 uses one or more servers to receive sale and use data 106. The servers may be implemented in a similar manner as those described with respect to jurisdictions 108. Additionally, data center 110 may send and receive data with jurisdictions 108. For example, users 102 may transmit sales and uses data 106 to jurisdictions 108 which may in turn transmit it to data center 110 for processing.

Communications between user terminals 104, jurisdictions 108, and data center 110 may be completed using one or more networks. In various embodiments, a network may include local-area networks (LAN), wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. A network may include a single local area network (LAN) or wide-area network (WAN), or combinations of LAN's or WAN's, such as the Internet. The various devices (e.g., user terminals or servers) coupled to the network may be coupled to the network via one or more wired or wireless connections.

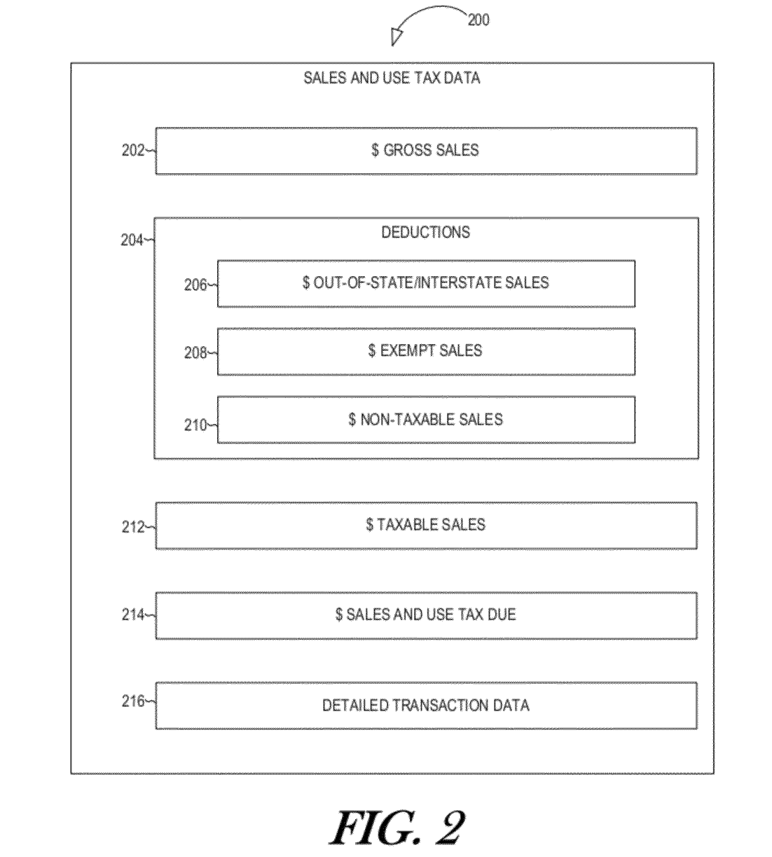

FIG. 2 illustrates an example sale and use tax form 200. While FIG. 2 is discussed with respect to a state, any type of jurisdiction may be used (e.g., a territory, city). Shown are gross sales 202, deductions 204, out-of-state/interstate sales 206, exempt sales, 208, non-taxable sales 210, taxable sales 212, sales and use tax due 214, and detailed transaction data 216.

With respect to FIG. 2, consider a business based in Minnesota. At the end of a reporting period (e.g., quarterly, monthly), the business will file a sales and use tax return, similar to sales and use tax form 200, with the state of Minnesota. The return will include the gross sales 202 the company had for the reporting period as well as list the total deductions 204, in dollars, the company is entitled to. These deductions may include, but are not limited to, out-of-state sales 206 (also sometimes referred to interstate sales or sales in interstate commerce), exempt sales 208, and non-taxable sales 210. The total of deductions 204 are subtracted from gross sales 202 to determine taxable sales 212 that is then multiplied by the sales and use tax rate for Minnesota to determine sale and use tax due 214.

In an embodiment, out-of-state sales/interstate sales are defined by sales in which delivery takes place out-of-state. For example, the Minnesota-based company does not need to remit sales tax on items which are delivered to California. However, if a California resident purchases goods from the Minnesota company and picks them up in Minnesota, it is not an out-of-state sale for the purposes of the sales and use tax.

In an embodiment, exempts sales 208 are sales to an entity that has exempt status. Entities that are exempt from sales tax may be identified by an exemption certificate. An exemption certificates may include purchaser's name and address, purchaser's tax ID number and state of issue, or if none, purchaser's FEIN, or if none, purchaser's driver's license number, seller's name and address, purchaser's type of business, reason exemption is claimed, purchaser's signature and date. Different jurisdictions may have different requirements to obtain exempt status. Additionally, an entity which is exempt in one jurisdiction may not be exempt in a different jurisdiction.

In an embodiment, non-taxable sales 210 are sales in categories that a jurisdiction has determined are not to be taxed. Categories of sales may include, but are not limited to, clothing, groceries, prescription drugs, non-prescription drugs, prepared food, alcohol, energy, gasoline, fundraising sales, services, medical equipment, prizes, property, resale, and various types of equipment. Each jurisdiction may use different non-taxable sales categories. Additionally, jurisdictions may use different levels of granularity with respect non-taxable sales. For example, one jurisdiction may treat all food as non-taxable no matter where the food is purchased. Another jurisdiction may only treat food sold in a grocery store as non-taxable. Some jurisdictions may use a granularity down to a store-keeping unit (SKU) identifier.

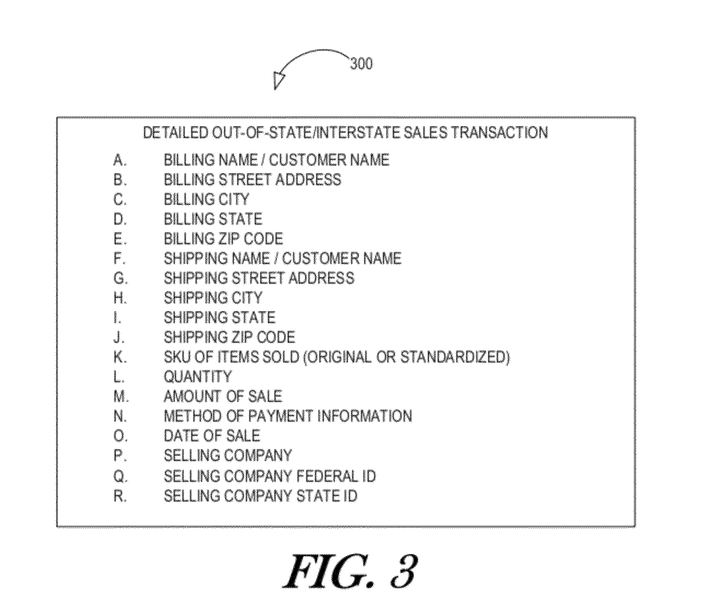

In addition to the dollar amounts discussed, a company may provide detailed transaction data 216. While the examples generally use a company entity, individuals or other entities which are involved in commerce may be used. Detailed transaction data 216 may be used to ensure that the a company is entitled to the deductions claimed. FIG. 3 illustrates example information which may be required to be included for out-state-sales. In various embodiments, only a subset of the information shown in FIG. 3 is required. Different types of information may be required for the different deduction types. For example, with respect to exempt sales, a copy of the exemption certificate may be required in addition to the information shown in FIG. 3.

In an embodiment, the format of the detailed transaction data 216 is defined in a standard format. For example, a schema may be defined using extensible markup language (XML). The schema may be translated and presented in a variety of forms to a user that enters in the detailed transaction data. Received and entered transaction data may be validated against the schema to ensure all the necessary information has been entered and is in the correct form.

In an embodiment, a user may browse to a website hosted by data center 110 and be presented with a web-form asking for the detailed transaction data that is associated with a sales and use tax return. The data center may validate the information against the XML schema and notify the business user (e.g., display a textual or graphical element on the website) if errors were found in the detailed transaction data. Data center 110 may also present a confirmation if the data is validated.

In various embodiments, detailed transaction data may periodically (e.g., daily, quarterly) be batch uploaded to data center 110. For example, user 102 may format the detailed transaction data on user terminal 104 in a manner specified by data center 110. This data may then be transmitted to data center 110 where it is processed and validated. Thus, thousands or millions of detailed transaction data may be uploaded at once. If errors are found in the detailed transaction data, data center 110 may notify (e.g., by electronic mail) the user as to which pieces of detailed transaction data need to be corrected. In various embodiments, user 102 may upload detailed transaction data in a non-standard format. The non-standardized data may then be translated to the standard form at data center 110. While the previous example embodiments have been discussed with transmitting the detailed transaction data to data center 110, severs associated with jurisdictions 108 may also be used.

In various embodiments, data center 110 performs at least four functions: (1) extracts transaction information from detailed transaction data; (2) privatizes the transaction data; (3) determines a jurisdiction of a transaction; and (4) synchronizes transaction data between the jurisdictions. A brief description of each of these functions is given first with a more detailed description given later in the document. In various embodiments, these functions are performed in whole or in part on user terminals 104, at jurisdictions 108, or at data center 110. In various embodiments, these functions are performed using modules, components, or logics executed on a computing device.

With respect to the extraction of information, data center 110 may store one or more entries in a table of a database (e.g., relational or flat file) corresponding to the detailed transaction data received. Each piece of information extracted from the detailed transaction data may be stored in a separate data field of table entry.

With respect to the privatization of the detailed transaction data, data center 110 may translate some of the data into a different form. In an example embodiment, the SKU extracted by data center 110 may be translated to a generic version of the SKU. For example, a SKU provided in the detailed transaction data may indicate a specific product for sale (e.g., brand X polo shirt, size small). Data center 110 may translate the SKU into a generic shirt SKU. Thus, a general idea of a sale may be given to a third party while the actual item for sale provided in the detailed transaction data is made private.

In an example embodiment, detailed transaction data includes a data representing the shipping location of the sale. Data center 110 may examine the shipping location data to determine the jurisdiction where sales and use tax is applied, if any. For example, the shipping location data may include a zip code. Data center 110 may use that zip code to look up a jurisdiction (e.g., a state) associated with the zip code. In some examples additional checking may done using the address data provided in the detailed transaction data to verify the proper jurisdiction has been determined

In various embodiments, transaction data between the states is synchronized. For example, upon completion of extracting the detailed transaction data, privatizing the data, and determining a jurisdiction, data center 110 may have a database containing multiple records that include privatized SKU data and an associated jurisdiction. Data center 110 may then transmit the information contained in the database records to the corresponding jurisdiction. For example, a database record may indicate that a bottle of wine was shipped to a Minnesota address. Data center may transit information contained in that database record to a processing server associated with Minnesota where it may be further processed to determine if an invoice should be sent to collect tax that may have been unpaid. In various embodiments, data center 110 checks use tax exemptions for a jurisdiction before transmitting the data. For example, clothes are generally not taxed in Minnesota. Thus, if data center 110 had a database record indicating a shirt was shipped to Minnesota from California, data center 110 may not send any of the detailed of the transaction to a server/entity associated with processing tax records for Minnesota.

Referring back to FIG. 1A, data center 110 is illustrated with a transaction extraction component. In an embodiment, transaction extraction component implements functionality associated with extracting transaction information from received detailed transaction data. As part of this process, the transaction extraction component may parse the detailed transaction data and store all of part of the data in a transaction database record (e.g., a row of data) of a transaction database. For example, if the information is that as described in FIG. 3, a database record may be created that includes columns (also referred to a data fields) of:

a. Billing name/Customer name

b. Billing street address

c. Billing city

d. Billing state

e. Billing zip code

f. Shipping name/customer name

g. Shipping street address

h. Shipping city

I. Shipping state

j. Shipping zip code

k. SKU of items sold (original or standardized)

l. Quantity

m. Amount of sale

n. Method of payment information

o. Date of Sale

p. Selling Company

q. Selling Company Federal ID

r. Selling Company State ID

s. E-mail

The column names and order are exemplary in nature and variations may be used in storing database records. Additionally, some of the columns may be combined or omitted. In various embodiments, data center 110 receives detailed transaction data from multiple user terminals and jurisdictions. The transaction extraction component may keep records of which entity supplied the detailed transaction data and the time it was received.

In an embodiment, the transaction database record includes a column of sellers. In an embodiment, the seller is the entity that has filed the sales and use tax return for the transaction. Thus, the database may be queried to retrieve all the transactions records associated with a seller in a given time period.

In various embodiments, data center 110 deletes database records after a period of time (e.g., three years). Different jurisdictions may have different limitations on how far back in time sales and use tax may be audited. Therefore, the period of time the database records are stored may vary by jurisdiction and entity.

Referring back to FIG. 1A, a transaction privatization component may obscure some or all of the transaction details stored in a transaction database record in order to privatize the transaction data. For example, the SKU data field may be translated from the SKU of the product as purchased to a standardized SKU form. In an embodiment, a SKU is an alphanumeric identifier that uniquely identifies a product/service for sale. A product may have more than one SKU depending on packing and promotions. For example a video game may have one SKU for a regular version of the game a different SKU for an anniversary edition of the game. Different SKUs may also be used depending on where an item is for sale. For example, a stereo receiver that is sold in a brick-and-mortar store may have one SKU while the same receiver sold from an internet merchant may use a different SKU.

In an embodiment, a standardized SKU form allows a requesting entity enough information to determine if the product is exempt from use tax for a jurisdiction. For example, clothing is exempt from sales and use tax in some jurisdictions. Therefore, if the shipping address is in a jurisdiction where clothing is exempt, a generic clothing SKU may be stored in the transaction database record. Different granularities may be used for different jurisdictions. In an embodiment, the standardized SKUs are the same for all jurisdictions.

In an embodiment, data center 110 stores SKU conversion data to facilitate the privatization process. In an embodiment, the SKU conversion data is available to entities and users outside of data center 110. Thus, users may privatize the SKUs on their detailed transaction data before transmitting a sales and use tax return. In an embodiment, the SKU conversion data is stored as one or more lookup tables or associative arrays. An example method of using the lookup-table is as follows. First, the transaction extraction component creates and stores a transaction record with the original SKU. Then, the transaction privatization component uses the SKU in the transaction record as an index into the SKU conversion lookup table to determine the standardized SKU. In an embodiment, the original SKU data field is replaced with the standardized SKU in the transaction record. In an embodiment, the standardized SKU is stored in a standardized SKU data field of the transaction record, leaving the original SKU in the transaction record.

Referring back to FIG. 1A, in an embodiment, a jurisdiction resolver component determines the jurisdiction where a sales and use tax may be owed. As discussed, the location of a delivery of an item determines the jurisdiction where a use tax may be owed. Thus, the jurisdiction resolver component may access the shipping information stored in a transaction record to determine the proper jurisdiction. In various embodiments, the jurisdiction may resolve to a state. In an embodiment, more than one jurisdiction may be determined to be associated with a transaction.

In an embodiment, a check is completed that the street address, zip code, and state match (e.g., are in the same jurisdiction). Consider a situation in which clothes are exempt from tax in state A, but are taxed in state B. Thus, a person living in state B, but near the border, may list his correct street address, but purposely list state A in a clothing order in order to avoid paying the sales tax. The jurisdiction resolver component may translate the street address to its associated location coordinates (longitude and latitude). Thus, data center may determine with near certainty which jurisdiction a transaction is associated with. To facilitate this process, data center 110 may store location coordinate data in one or more storage devices. The location coordinate data may include the legal metes and bounds in global positioning coordinates of the various jurisdictions.

An example method of using the jurisdiction resolver component is as follows. First, the jurisdiction resolver component retrieves a transaction record from a database. Then, the jurisdiction resolver looks at the data fields associated with the shipping address. Next, the shipping street address and city are translated into GPS coordinates. Afterwards, the GPS coordinates are used as inputs to query the location coordinate data. In an embodiment, the output of the query is data representing a jurisdiction (e.g., zip code, city, state, territory). The determined jurisdiction is stored in the transaction record in a jurisdiction data field. In an embodiment, detailed transaction data includes the GPS coordinates or address of a location that a product was delivered to. This may be different than a listed shipping address. Thus, the jurisdiction resolver component may use the delivery coordinates or address to determine the relevant jurisdiction.

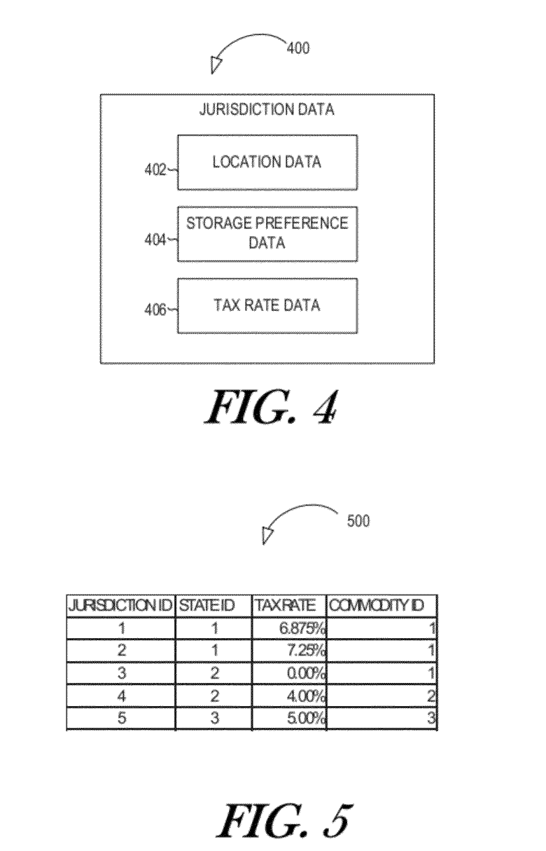

Referring back to FIG. 1A, a jurisdiction synchronization component synchronizes transaction data between jurisdictions. To facilitate the synchronization, data center 110 may use jurisdiction data stored on one or more storage devices of data center 110. FIG. 4 is an example diagram of jurisdiction data 400 that may be stored for a jurisdiction. Illustrated is location data 402, storage preference data 404, and taxability matrix data 406.

In an embodiment, location data 402 includes GPS coordinates that define the boundaries of a jurisdiction. The location data may be a subset of the information stored as location coordinate data with reference to FIG. 1A. Location data 402 may also include zip codes and street addresses that are associated with the jurisdiction.

In an embodiment, storage preference data 404 includes data representing storage retention policies for a jurisdiction. A storage retention policy may be stored as a value that represents the length of time data center 110 is to retain transaction records. For example, Minnesota may wish to keep transaction records with shipping addresses within its jurisdiction for four years.

In an embodiment, taxability matrix data 406 includes data representing the sales and use tax rates for a jurisdiction. A jurisdiction may have more than one tax rate depending on the category of a transaction (e.g., alcohol might be taxed at a higher rate). In an embodiment, one or more SKUs (standardized or original) in a category of goods are aggregated together to form a commodity grouping. In an embodiment, a commodity table is stored in a database. The commodity table may associate a commodity ID with one or more SKUs.

For a jurisdiction, the taxability matrix may include tax rate database records for each commodity grouping. Therefore, if a particular group of commodities is exempt from taxation within a jurisdiction, the tax rate may be stored as 0%. The taxability matrix also allows flexibility if either the jurisdiction changes tax rates for a commodity grouping or if the jurisdiction wishes to move a SKU from one commodity grouping to a different commodity grouping.

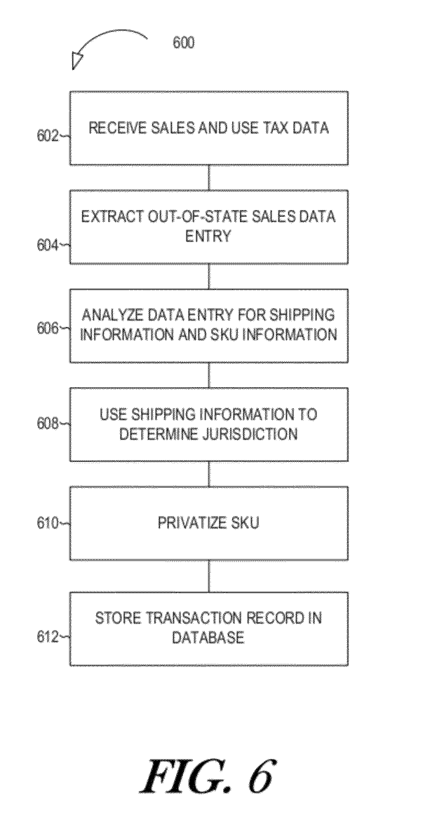

FIG. 5 is an example database table 500 that may generated by querying data stored in one or more storage devices of the data center. Illustrated is a table including Jurisdiction ID, State ID, Tax Rate and Commodity ID for five sample jurisdictions. The data included in the table is exemplary in nature and is not intended to be factually accurate. Similarly, other layouts and combinations of data may be used. As illustrated, Jurisdiction IDs ‘1’ and ‘2’ are associated with state ID ‘1’. The jurisdictions may be counties within Minnesota, for example. A jurisdiction table may associate the jurisdictions with the states. As shown, there are two different rates for commodity ID ‘1’ for the jurisdictions ‘1’ and ‘2’ and there is no tax on commodity ID ‘1’ for jurisdiction ‘3.’ This may mean that the SKUs associated with commodity ID ‘1’ are exempt from sales tax within jurisdiction ‘3.’

In an embodiment, the commodity IDs may be associated with exemption data that includes SKUs for that category of commodity. For example, a commodity grouping of groceries may be stored as a row of database records of SKUs that qualify as grocery items for a particular jurisdiction. In various embodiments, the SKUs in the list are the standardized SKUs such as those used to privatize the detailed transaction data. In various embodiments, there may be more than one list stored for each exemption category. For example, Minnesota may have a different set of SKUs which qualify for clothing than New Jersey. Therefore, in an embodiment, when data center 110 receives detailed transaction data, the jurisdiction data may be queried to determine which jurisdiction is associated with a transaction as well what tax, if any, is owed. In an embodiment, the groupings of commodities are consistent between jurisdictions thus negating the need for jurisdiction specific groupings of SKUs.

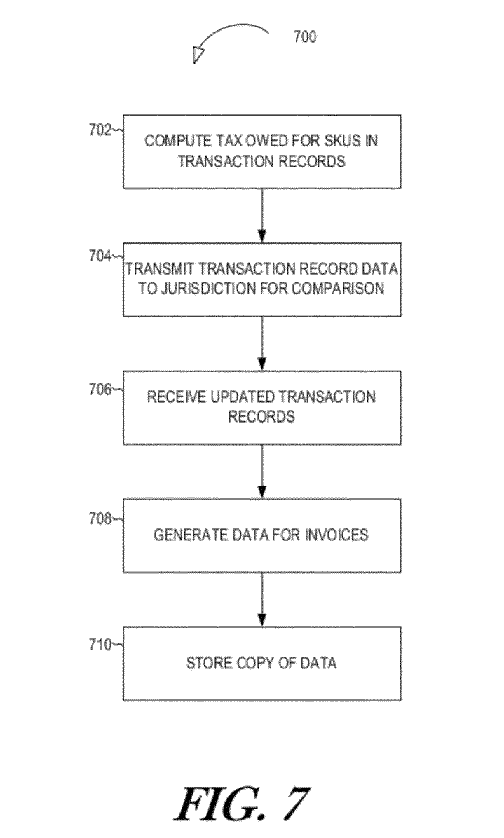

FIG. 6 is a flow chart illustrating a method 600, in accordance with an example embodiment, to process detailed transaction data. The method 600 may be performed by any of the modules, logic, or components described herein.

At block 602, in an embodiment, sales and use tax data is received at a data center. The sales and use tax data may be received from a user's terminal or other computing device. In an embodiment, the data is a received from an entity associated with processing tax information for a jurisdiction. The sales and use tax data may be associated with a single entity (e.g., company or person) or may include data for multiple entities. The sales and use tax data may include multiple transaction details associated with an entity. In various embodiments, the sales and use tax data is received in an encrypted format.

At block 604, in an embodiment, an out-of-state/interstate sales data entry is extracted from the receives sale and use tax data. An out-of-state sales data entry may be in the form of detailed transaction data as described in FIGS. 2 and 3.

At block 606, in an embodiment, the data entry is analyzed for shipping information and SKU information. For example, the data entry may include a field or heading signifying shipping location and SKU information. The information in these fields may be examined to determine a shipping address and a SKU of a product or service. In various embodiments, the data entry is an XML document.

At block 608, the shipping information is used to determine a jurisdiction. For example, the shipping information may include an address. The shipping address may be used to determine GPS coordinates. The GPS coordinates may be used as an input to a jurisdiction resolver component (as described with reference to FIG. 1A) to determine in which jurisdiction the GPS coordinates are located. In an embodiment, the zip code of the shipping information is used to determine a jurisdiction. In an embodiment, an ID associated with the jurisdiction is determined.

At block 610, the SKU information in the data entry is privatized. In an embodiment, the SKU information is privatized using a transaction privatization component as described with respect to FIG. 1A.

At block 612, in an embodiment, a transaction record is stored in a database. In an embodiment, the transaction record includes the data in the out-of-states sales data entry.

FIG. 7 is a flow chart illustrating a method 700, in accordance with an example embodiment, to generate invoices. The method 700 may be performed by any of the modules, logic, or components described herein.

At block 702, tax owed for SKUs stored in transaction records is computed. For example, the commodity ID of the SKU may be determined. The commodity ID and ID of the jurisdiction of the transaction record may be used an input to a taxability matrix. In an embodiment, the taxability matrix has the tax rate for the commodity ID in the jurisdiction ID. The determined tax rate is multiplied by the amount of sale data field of the transaction record to determine a tax owed. The tax owed may be stored in a data field of the transaction record. Furthermore, a data field may indicate that a transaction record has not been billed if the tax owed is greater than zero.

At block 704, in an embodiment, transaction record data is transmitted to a jurisdiction for comparison with filed sales and use tax returns. For example, transaction records may be batched together by jurisdiction. The batched transaction records may then be transmitted to a processing server associated with the jurisdiction. In various embodiments, the data center stores data related to received sales and use tax returns. Therefore, the transmission of the transaction records may be omitted.

In various embodiments, it is determined for each transaction record whether or not sales tax has already been paid. In an embodiment, as a first step, a check may be completed using the total amount of sales tax owed for a company (e.g., grouping sales tax owed by billing name/customer name) with tax received from that company. If the tax received is greater than or equal to the tax owed individual transaction records may not need to be examined

At block 706, in an example embodiment, updated transaction records are received. The updated transaction records may include an indication of whether or not an invoice to be generated related to the transaction record. For example, if it is determined that a company has already paid sufficient sales tax, each transaction record with the company may be updated to indicate the tax has been paid in full. Conversely, if it is determined that a company owes sales tax transaction records associated with that company may be updated to indicate that an invoice needs to be generated. While an entity of a company is being used in the previous examples, other entities such as individuals may also be used.

At block 708, in an example embodiment, data is generated for invoices on tax owed for a transaction according to the updated transaction records. The data may include: a letter describing the amount owed for use tax, the use tax form for the relevant state ready for signature and filing, and the detailed transactions being taxed including: amount of transaction(s), where purchased (reported), state reporting, and the amount of tax calculated on each item. In an embodiment, detailed transaction information is omitted. The data may be transmitted to the jurisdiction to perform the invoicing and collection of tax. In an embodiment, an invoice is generated using the data and mailed.

In an embodiment, company may pay the tax to an entity other than the jurisdiction where the tax is owed. The entity may, in return for managing the generation of invoices and collection of taxes owed, reduce the tax owed by a percentage or flat fee. The remainder may then be sent to the jurisdiction that is owed the tax.

At block 710, a copy of the data for the invoice may be stored in the data center for archival purposes.

In various embodiments, further functionality may include data mining tools to determine trends and locate potential fraud. For example, to detect fraud, the system may analyze sales and use tax records for irregularities based on average tax percentages. If a company falls outside of the average by a certain threshold (e.g., two standard deviations) an alert may be placed on the company for a potential audit. A user interface may be provided that allows a user to specify certain traits of a company to help refine the fraud detection. Traits may include type of sales, locations of sales, type of business, and size of business (e.g., revenue, employees). Thus, an auditor may look at the average use tax paid for a mid-sized clothing company compared to a potential audit target.

In an embodiment, an API is provided to allow third party users to access the data stored within the system described herein. In an embodiment, identifying information of the companies is not exposed via the APIs.

While the above descriptions have focused on out-of-states sales tax, this disclosure may be used for other tax calculating purposes. For example, transaction records may be analyzed for sales that are tax exempt for a given company. These may include, depending on the jurisdiction, agriculture, direct payment, government exemptions, manufacturing, and resale transactions.

Example Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

Example Machine Architecture and Machine-Readable Medium

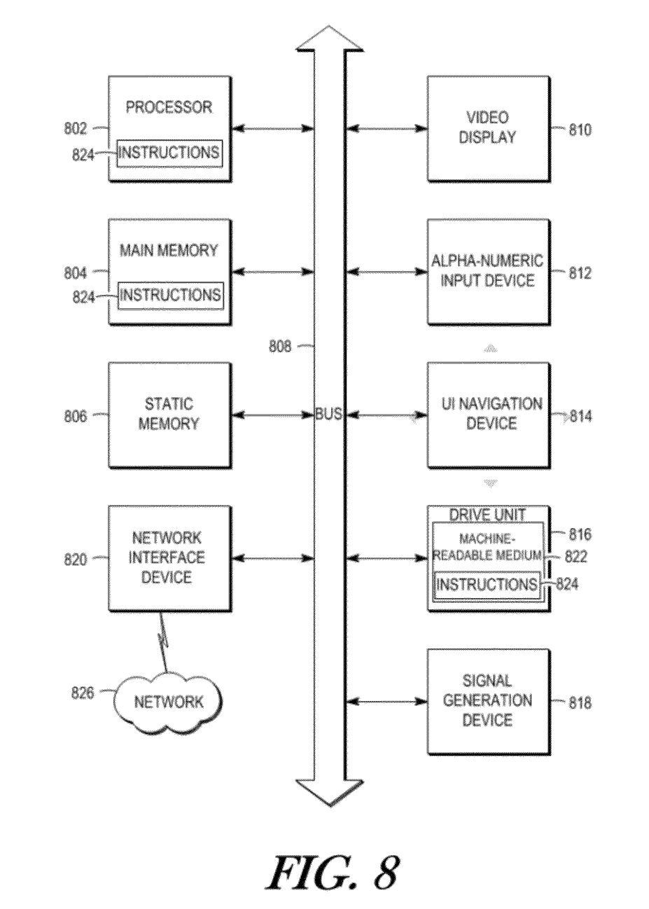

FIG. 8 is a block diagram of machine in the example form of a computer system 800 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processing device 802 (e.g., a central processing unit (CPU), a graphics processing unit (GPU), or ASIC), a main memory 804 and a static memory 806, which communicate with each other via a bus 808. The computer system 800 may further include an output device such as video display unit 810 (e.g., a liquid crystal display (LCD) or a cathode ray tube (CRT)). The computer system 800 also includes an alphanumeric input device 812 (e.g., a keyboard), a user interface (UI) navigation device 814 (e.g., a mouse), a disk drive unit 816, a signal generation device 818 (e.g., a speaker) and a network interface device 820.

Example Machine-Readable Medium

The disk drive unit 816 includes a machine-readable medium 822 on which is stored one or more sets of instructions and data structures (e.g., software) 824 embodying or utilized by any one or more of the methodologies or functions described herein. The instructions 824 may also reside, completely or at least partially, within the main memory 804 and/or within the processor 802 during execution thereof by the computer system 800, the main memory 804 and the processor 802 also constituting machine-readable media.

While the machine-readable medium 822 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Example Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
at least one computing system comprising:
a processing device;
an input device;
an output device;
a storage device; and
a network device; and
a computer program to configure the at least one computing system to:
receive, via the network device, sales and use tax data;
store, on the storage device, the received sales and use tax data;
extract an interstate sales entry from the stored sales and use tax data;
analyze, using the processing device, the interstate sales entry to determine a jurisdiction associated with the interstate sales entry;
privatize a SKU in the interstate sales entry; and
store a transaction record in a database on the storage device, the transaction record including the determined jurisdiction and the privatized SKU.

2. The system of claim 1, wherein the computer program is to configure the at least one computing system to store, in the database, a plurality of records correlating a specific SKU with a generic SKU.

3. The system of claim 2, wherein the computer program is to configure the at least one computing system to private the SKU in the interstate sales entry by:
querying the database to determine the generic SKU associated with the SKU in the interstate sales entry; and
using the determined generic SKU as the privatized SKU.

4. The system of claim 1, wherein the computer program is to configure the at least one computing system to store, in the database, location data defining a plurality of jurisdictions, the location data including coordinate data.

5. The system of claim 4, wherein the computer program is to configure the at least one computing system to analyze the interstate sales entry to determine the jurisdiction associated with the interstate sales entry by:
parsing the interstates sales entry to determine a shipping address listed in the sales entry; and
querying the database with GPS data associated with the shipping address to determine a jurisdiction associated with the shipping address.

6. The system of claim 5, wherein the computer program is to configure the at least one computing system to:
compare the determined jurisdiction with a jurisdiction listed in the sales entry; and
store an indication in the database that the sales entry is potentially fraudulent when the listed jurisdiction and determined jurisdiction do not match.

7. The system of claim 1, wherein the computer program is to configure the at least one computing system to calculate a tax owed on the interstate sale based on the determined jurisdiction.

8. The system of claim 1, wherein the sales and use tax data is encrypted.

9. The system of claim 8, wherein the computer program is to configure the at least one computing system to decrypt the sales and use tax data before extracting the interstate sales entry.

10. A system comprising:
at least one computing system comprising:
a processing device;
an input device;
an output device;
a storage device; and
a network device; and
a computer program to configure the at least one computing system to: store, on the storage device, a taxability matrix;
retrieve a record from a database on the storage device, the record including a commodity identifier, a jurisdiction identifier, and an amount of a sale;
query the taxability matrix using the commodity identifier and jurisdiction identifier as inputs;
determine a tax rate in response to the query; and
calculate, using the processing device, tax owed for a product associated with the record by multiplying the tax rate by the amount of the sale.

11. The system of claim 10, wherein the storage device stores an amount of sales and use tax paid for an entity.

12. The system of claim 11, wherein the computer program is to compare the calculated tax owed to the sales and use tax paid for the entity.

13. The system of claim 12, wherein the computer program is to configure the at least one computing system to transmit, via the network device, the difference between the calculated tax owed to the sales and use tax paid for the entity to a taxing jurisdiction.

14. The system of claim 12, wherein the computer program is to configure the at least one computing system to update the record when the difference between the calculated tax owed and the sales and use tax paid for the entity is zero, the updated record indicating a paid status.
